(19) United States
(12) Patent Application Publication
(10) Pub. No.: US 2019/0275823 A1
(43) Pub. Date: Sep. 12, 2019

(54) BINDING STRUCTURE, BINDING APPARATUS, AND BINDING METHOD

(71) Applicant: KONICA MINOLTA, INC., Tokyo (JP)

(72) Inventors: MADOKA OKABE, Toyokawa-shi (JP); FUMINORI KOBAYASHI, Toyokawa-shi (JP); MUTSUTO OE, Toyokawa-shi (JP); HIROMI MIZUGUCHI, Toyokawa-shi (JP)

(21) Appl. No.: 16/268,372

(22) Filed: Feb. 5, 2019

(30) Foreign Application Priority Data
Mar. 7, 2018 (JP) 2018-041132

(51) Int. Cl. B42B 5/00

(52) U.S. Cl. CPC B42B 5/00

(57) ABSTRACT

A binding structure that binds a bundle of recording media, the binding structure includes an inserted elastic body that is stretchable and inserted through a through hole formed in the bundle of the recording media, wherein the inserted elastic body includes an insertion part that extends along a thickness direction of the bundle of the recording media and is inserted through the through hole, and a pair of sandwiching parts that is provided at both ends of the insertion part in the thickness direction and sandwiches the bundle of the recording media, and the insertion part is in an extended state to cause the pair of sandwiching parts to generate elastic biasing force in a direction in which the bundle of the recording media is sandwiched.

The entire disclosure of Japanese patent Application No. 2018-041132, filed on Mar. 7, 2018, is incorporated herein by reference in its entirety.

### BACKGROUND

### Technological Field

The present invention relates to a binding structure, a binding apparatus, and a binding method.

### Description of the Related Art

A technique for binding a sheet bundle is disclosed in JP 2013-31977 A.

In a binding method of a sheet bundle disclosed in JP 2013-31977 A, a configuration is adopted for binding a sheet bundle by inserting a binding member including a thermoplastic resin into a hole part penetrating the sheet bundle, and heating the thermoplastic resin.

However, in the above configuration, since the binding member and the sheet bundle are bonded together, it is difficult to remove the binding member limn the sheet bundle, and if the binding member is removed from the sheet bundle, the sheet may be damaged. In addition, even if the sheet can be removed without damaging the sheet, the resin material may remain and give a dirty impression. Further, since the configuration requires a heat source mechanism, manufacturing costs are increased.

### SUMMARY

An object of the present invention is to provide a binding structure, a binding apparatus, and a binding method that make it possible to easily remove a binding member with simple configurations.

To achieve the abovementioned object, according to an aspect of the present invention, a binding structure that binds a bundle of recording media reflecting one aspect of the present invention comprises an inserted elastic body that is stretchable and inserted through a through hole formed in the bundle of the recording media, wherein the inserted elastic body includes an insertion part that extends along a thickness direction of the bundle of the recording media and is inserted through the through hole, and a pair of sandwiching parts that is provided at both ends of the insertion part in the thickness direction and sandwiches the bundle of the recording media, and the insertion part is in an extended state to cause the pair of sandwiching parts to generate elastic biasing force in a direction in which the bundle of the recording media is sandwiched.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic perspective view illustrating it binding apparatus of a first embodiment;

FIG. 2 is a schematic perspective view illustrating a state when an undeformed elastic body is inserted through a through hole;

FIG. 3 is a schematic cross-sectional view illustrating the state when the undeformed elastic body is inserted through the through hole;

FIG. 4 is a schematic perspective view illustrating a state in which an insertion device releases pulling of a deformed elastic body;

FIG. 5 is a schematic view illustrating a state in which an inserted elastic body is cut;

FIG. 6 is a schematic cross-sectional view illustrating the inserted elastic body after being cut;

FIG. 7 is a schematic perspective view of the inserted elastic body after being cut;

FIG. 8 is a view illustrating a sheet bundle in which there is one place of the through hole;

FIG. 9 is a view illustrating a sheet bundle in which there are two places of the through hole;

FIG. 10 is a flowchart illustrating steps of a binding method of a sheet bundle in the first embodiment;

FIG. 11 is a cross-sectional view illustrating an undeformed elastic body of to second embodiment inserted through a through hole;

FIG. 12 is a cross-sectional view illustrating an undeformed elastic body of a third embodiment inserted through a through hole;

FIG. 13 is a schematic perspective view illustrating a binding apparatus of a fourth embodiment;

FIG. 14 is a schematic cross-sectional view of a binding structure of the fourth embodiment;

FIG. 15 is a schematic perspective view of a sheet bundle after being bound;

FIG. 16 is a schematic perspective view illustrating a binding apparatus of a fifth embodiment;

FIG. 17 is a schematic perspective view of a crochet hook that pulls an undeformed elastic body in one direction of thickness directions;

FIG. 18 is a schematic perspective view illustrating a state in which an inserted elastic body of a fifth embodiment is cut;

FIG. 19 is a schematic cross-sectional view illustrating a binding structure of a sixth embodiment;

FIG. 20 is a schematic perspective view of an undeformed elastic body of the sixth embodiment;

FIG. 21 is a schematic cross-sectional view illustrating a binding apparatus of the sixth embodiment;

FIG. 22 is a schematic cross-sectional view illustrating the binding apparatus of the sixth embodiment immediately before the undeformed elastic body is inserted through a through hole;

FIG. 23 is a schematic cross-sectional view illustrating a deformed clastic body of the sixth embodiment;

FIG. 24 is a schematic cross-sectional view illustrating the deformed elastic body of the sixth embodiment immediately before the deformed elastic body is attached to a sheet bundle; and

FIG. 25 is a schematic cross-sectional view illustrating an inserted elastic body of the sixth embodiment.

### DETAILED DESCRIPTION OF EMBODIMENTS

Hereinafter, one or more embodiments of the present invention will be described with reference to the drawings. However, the scope of the invention is not limited to the disclosed embodiments. In the following embodiments, the same or corresponding parts are denoted by the same reference numerals, and description thereof will not be repeated.

### First Embodiment

<Binding Apparatus 1>

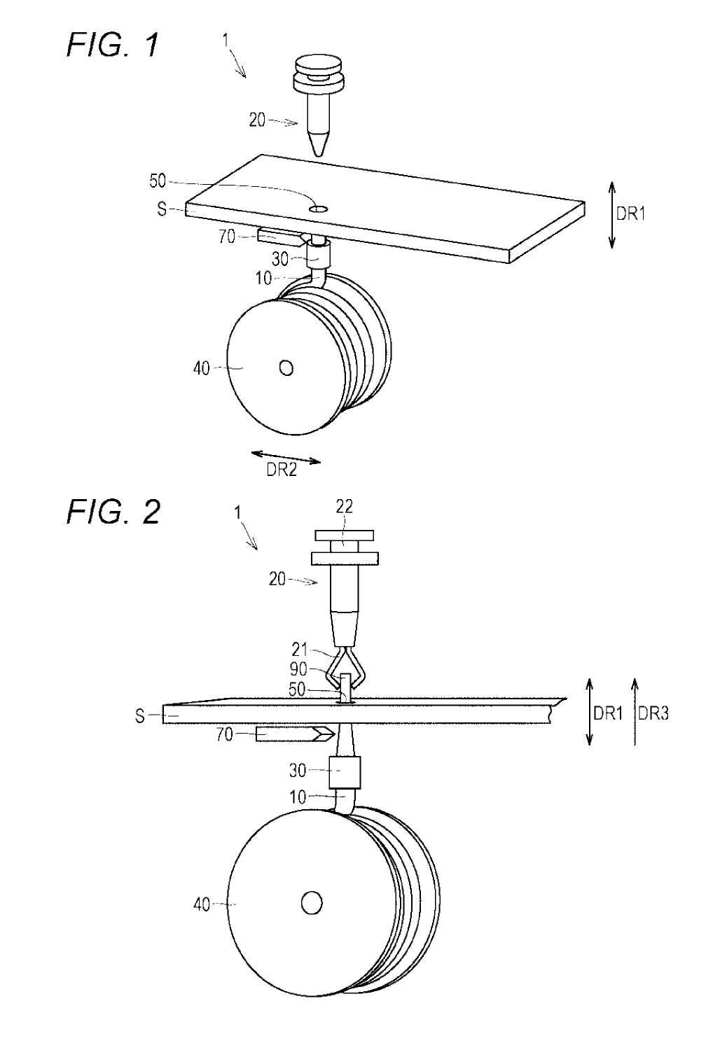

FIG. 1 is a schematic per view illustrating a binding apparatus 1 of a first embodiment. The binding apparatus 1 collectively binds a bundle of recording media. In the embodiment, the bundle of the recording media is a sheet bundle S.

Both arrows illustrated in FIG. 1 indicate thickness directions DR1 and first directions DR2. The thickness directions DR1 are thickness directions of the sheet bundle S, and are vertical directions in FIG. 1. The first directions DR2 are directions orthogonal to the thickness directions DR1, and are directions in which the sheet bundle S extends.

In the sheet bundle S, a through hole 50 is formed penetrating the sheet bundle S in the thickness directions DR1. In the first embodiment, the cross-sectional shape of the through hole 50 is circular. The binding apparatus 1 includes an insertion device 20, a holder 30, a winder 40, and a cutter 70. In the embodiment, as a binding member lilt binding the sheet bundle S, an undeformed elastic body 10 is used that is made of an elastic body and stretchable. By inserting the undeformed elastic body 10 through the through hole 50, the sheet bundle S is bound.

The undeformed elastic body 10 has a linear shape. The undeformed elastic body 10 has a tubular shape. In the first embodiment, the cross-sectional shape of the undeformed elastic body 10 is circular. The undeformed elastic body 10 has the length larger than the diameter of the through hole 50 in the first directions DR2. The diameter of the undeformed elastic body 10 is larger than the diameter of the through hole 50. The undeformed elastic body 10 is wound by the winder 40, thereby being arranged in a wound shape.

The insertion device 20 is arranged on an opposite side from the winder 40 and the undeformed elastic body 10 with respect to the sheet bundle S. The insertion device 20 has a configuration movable to a position corresponding to the through hole 50. The insertion device 20 is movable on the sheet bundle S. The insertion device 20 is movable in the thickness directions DR1. The insertion device 20 moves toward the undeformed elastic body 10 and grips the undeformed elastic body 10 and inserts the undeformed elastic body 10 through the through hole 50.

The holder 30 is arranged on an opposite side from the insertion device 20 with respect to the sheet bundle S. The holder 30 has a cylindrical shape. The undeformed elastic body 10 is inserted through the inside of the holder 30, whereby the holder 30 holds the undeformed elastic body 10.

The cutter 70 is arranged on the opposite side from the insertion device 20 with respect to the sheet bundle S. The cutter 70 is arranged on the same side as the holder 30 and the winder 40 with respect to the sheet bundle S. The cutter 70 is movable in the first directions DR2. The cutter 70 cuts a deformed elastic body 90 described later or an inserted elastic body 80.

FIG. 2 is a schematic perspective view illustrating a state when the undeformed elastic body 10 is inserted. through the through hole 50. The insertion device 20 includes a grip 21 and a main body 22. The grip 21 is provided inside the main body 22. The grip 21 protrudes from the main body 22 when gripping the undeformed elastic body 10.

An arrow illustrated in FIG. 2 indicates one direction DR3 of the thickness directions. The one direction DR3 of the thickness directions is one direction of the thickness directions DR1, and a direction in which the insertion device 20 pulls the undeformed elastic body 10. The one direction DR3 of the thickness directions is a direction in which the insertion device 20 separates from the winder 40 and the holder 30, and is the upward direction in FIG. 2.

After the undeformed elastic body 10 is gripped by the grip 21, the undeformed elastic body 10 is pulled in the one direction DR3 of the thickness directions, and the undeformed elastic body 10 is elastically deformed. The holder 30 arranged on the upstream side of the one direction DR3 of the thickness directions with respect to the sheet bundle S, holds the undeformed elastic body 10, whereby force acts pulling the undeformed elastic body 10 toward the upstream side of the one direction DR3 of the thickness directions, so that the undeformed elastic body 10 is elastically deformed easily.

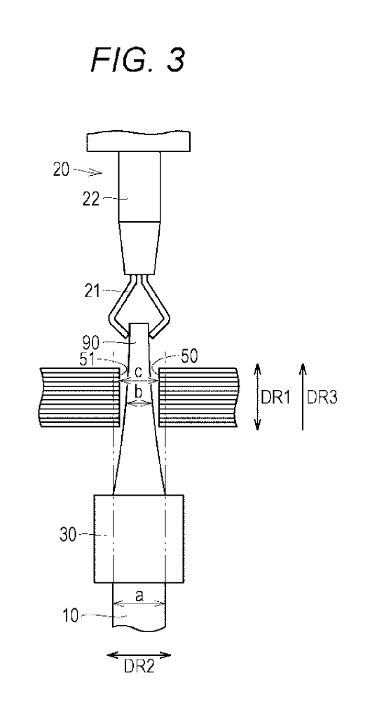

FIG. 3 is a schematic cross-sectional view illustrating a state when the undeformed elastic body 10 is inserted through the through hole 50. The insertion device 20 pulls the undeformed elastic body 10 in the one direction DR3 of the thickness directions, whereby the undeformed elastic body 10 is elastically deformed, and the undeformed elastic body 10 becomes the deformed elastic body 90. The deformed elastic body 90 is pulled by the insertion device 20, whereby the diameter (b in FIG. 3) of the deformed elastic body 90 becomes smaller than⁻the diameter (a in FIG. 3) of the undeformed elastic body 10. The diameter of the deformed elastic body 90 becomes smaller than the diameter (c in FIG. 3) of the through hole 50. As a result, the insertion device 20 can insert the deformed elastic body 90 through the through hole 50.

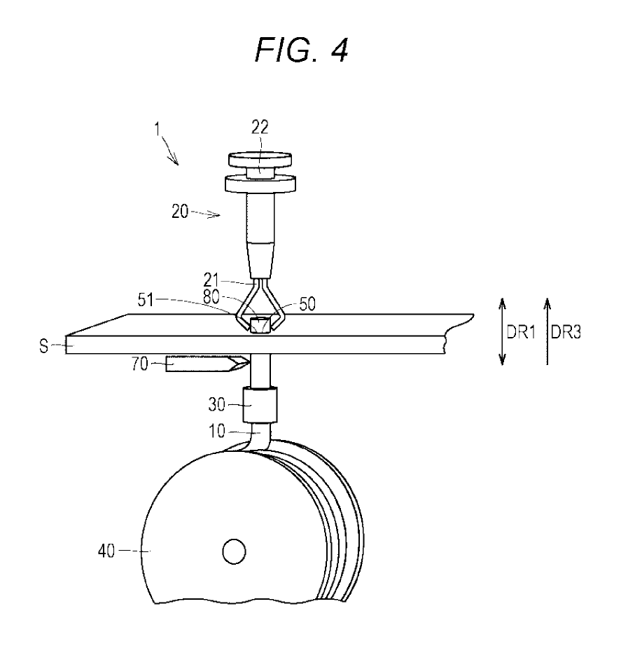

FIG. 4 is a schematic perspective view illustrating a state in which the insertion device 20 releases pulling of the deformed elastic body 90. After the deformed elastic body 90 is inserted through the through hole 50, the insertion device 20 releases pulling of the deformed elastic body 90 in the one direction DR3 of the thickness directions. As a result, the deformed elastic body 90 tends to return to its original shape (shape of the undeformed elastic body 10), and the outer diameter of the deformed elastic body 90 increases (the deformed elastic body 90 expands in the radial direction). When pulling is released after the deformed elastic body 90 is inserted through the through hole 50, the deformed elastic body 90 becomes the inserted elastic body 80. The inserted elastic body 80 is in a state after the undeformed elastic body 10 is inserted through the through hole 50. Since the diameter of the undeformed elastic body 10 is larger than the diameter of the through hole 50, the inserted elastic body 80 is in close contact with a peripheral wall part 51 of the sheet bundle S that defines the through hole 50.

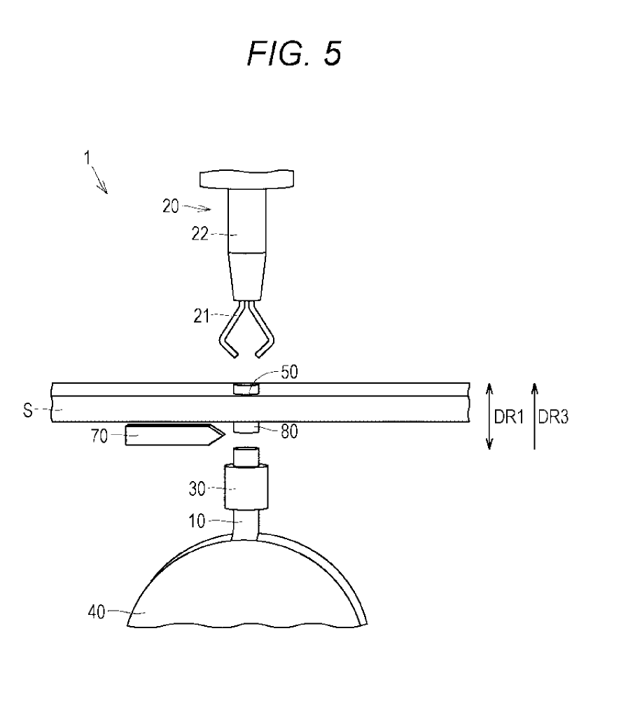

FIG. 5 is a schematic view illustrating a state in which the inserted elastic body 80 is cut. The cutter 70 cuts the inserted elastic body 80 on the upstream side of the one direction DR3 of the thickness directions with respect to the sheet bundle S. The cutter 70 cuts a part of the inserted elastic body 80 on the opposite side from the insertion device 20 with respect to the sheet bundle S. The cutter 70 cuts the inserted elastic body 80 between the sheet bundle S and the holder 30. After the inserted elastic body 80 is cut, the Sheet bundle S is bound by the inserted elastic body 80 left in the sheet bundle S.

<Binding Structure 2>

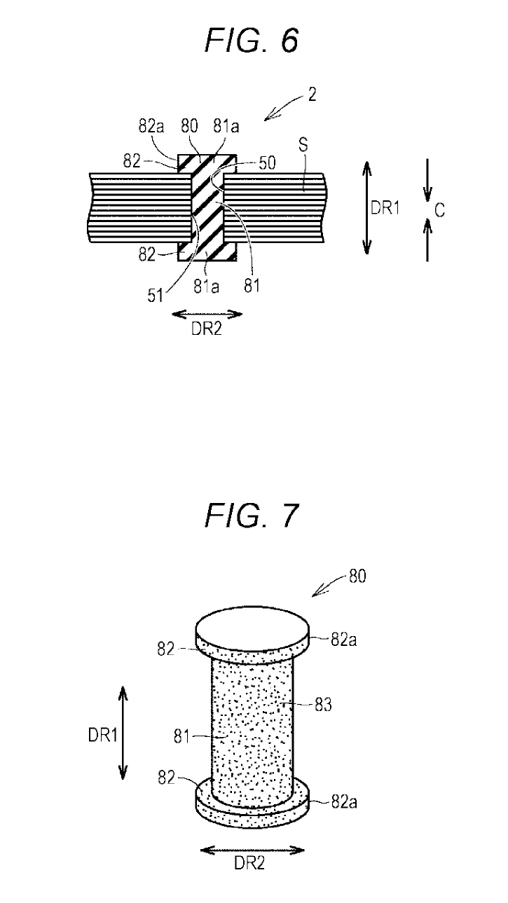

FIG. 6 is a schematic cross-sectional view illustrating the inserted elastic body 80 after being cut. FIG. 7 is a schematic perspective view of the inserted elastic body 80 after being cut. A binding structure 2 of the sheet bundle S will be described with reference to FIGS. 6 and 7.

The binding structure 2 includes the inserted elastic body 80 that is stretchable. The inserted elastic body 80 is inserted through the through hole 50. The sheet bundle S is bound by the inserted elastic body 80. The inserted elastic body 80 includes an insertion part 81 and a pair of sandwiching parts 82. The insertion part 81 is inserted through the through hole 50. The insertion part 81 extends along the thickness directions DR1. The insertion part 81 is inserted through the through hole 50 while remaining in an extended state. The insertion part. 81 is in close contact with the peripheral wall part 51 of the sheet bundle S that defines the through hole 50. Unevenness 83 is provided on the surface of the insertion part 81 (undeformed elastic body 10).

The sandwiching parts 82 each have a disk-like shape. The pair of sandwiching parts 82 is provided at both ends 81a of the insertion part 81 in the thickness directions DR1. The sandwiching parts 82 protrude in the first directions DR2 thin the both ends 81a, respectively. The sandwiching parts 82 extend in the radial direction of the insertion part 81. In the first embodiment, the sandwiching parts 82 are in contact with the sheet bundle S. In the first directions DR2, end parts 82a of the sandwiching parts 82 are provided outside the through hole 50. The end parts 82a are provided outside in the radial direction of the insertion part 81 from the through hole 50.

The pair of sandwiching parts 82 sandwiches the sheet bundle S. The pair of sandwiching parts 82 presses front and back surfaces of the sheet but S. One of the sandwiching parts 82 presses the front surface of the sheet bundle S, and the other of the sandwiching parts 82 presses the back surface of the sheet bundle S. The insertion part 81 is in the extended state to cause the pair of sandwiching parts 82 to generate elastic biasing force in a direction (C in FIG. 6) in which the sheet bundle S is sandwiched. Due to action of the insertion part 81 in the extended state contracting, the pair of sandwiching parts 82 generates the elastic biasing force on the sheet bundle S in the direction (C in FIG. 6) in which the sheet bundle S is sandwiched.

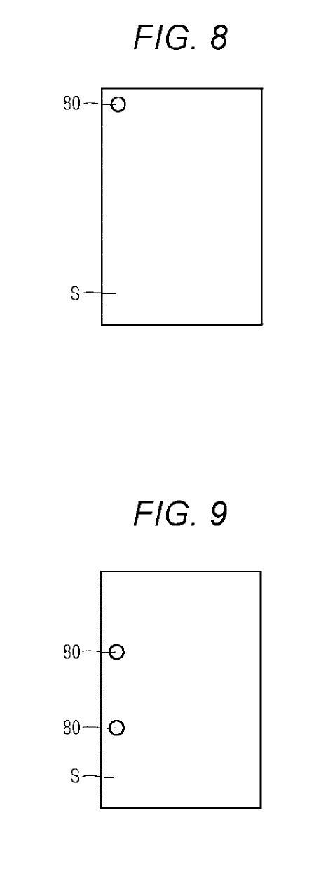

FIG. 8 is a view illustrating the sheet bundle S in which there is one place of the through hole 50. FIG. 9 is a view illustrating the sheet bundle in which there are two places of the through hole 50. There is a case where the sheet bundle S is bound at a corner (FIG. 8), a case where the sheet bundle S is bound at two points on the sheet bundle S (FIG. 9), or the like. The binding apparatus 1 of the first embodiment can be applied to any sheet bundle S.

### Function and Effect

As illustrated in FIG. 6, the undeformed elastic body 10 is it through the through hole 50 to generate the elastic biasing force in the direction (C direction in FIG. 6) in which the sheet bundle S is sandwiched after insertion. Since the sandwiching pans 82 press the sheet bundle S in the direction in which the sheet bundle S is sandwiched, force in a compression direction acts on the sheet bundle S. As a result, the sheet bundle S can be sandwiched by the sandwiching parts 82. Further, in the first directions DR2, the end parts 82a of the sandwiching parts 82 are provided outside the through hole 50, so that the inserted elastic body 80 can be prevented from coming off the sheet bundle S. Therefore, the sheet bundle S can be bound with the inserted elastic body 80 made of an elastic body.

A conventional metallic staple used as a binding member for binding a sheet bundle has a U-shaped configuration, and it is difficult to remove the metallic staple from the sheet bundle, and there is a case where injury is caused by sticking of the staple. Further, problems may occur such as mixing of the staple into food at a food site, a short circuit in a machine caused by the staple having entered the machine, damage of a shredder's blade caused by shredding of a sheet bundle with the staple attached.

By configuring the inserted elastic body 80 made of an elastic material as the binding member, problems can be eliminated such as injury caused by sticking of the staple, and a short circuit caused by the staple having entered the machine, so that it is possible to improve safety. Further, damage can be suppressed of the shredder's blade even when shredding is performed with a shredder.

In the above configuration, the sheet bundle S and the binding member are not bonded together, and the binding member is made of an elastic body, so that the binding member (the inserted elastic body 80 can be easily removed. Further, the sheet bundle S can be prevented from becoming dirty even after the inserted elastic body 80 is removed.

A heat source mechanism, which is necessary in the case of using a thermoplastic resin as the binding member, is unnecessary in binding the sheet bundle S, so that a configuration of the binding apparatus 1 can be simplified.

As described above, a configuration is adopted in which the sheet bundle S is bound by using the inserted elastic body 80 made of the elastic body as the binding member, whereby the binding apparatus 1 and the binding structure 2 can be implemented that make it possible to easily remove the binding member (inserted elastic body 80) with simple configurations.

As illustrated in FIG. 3, the undeformed elastic body 10 has the length (a in FIG. 3) larger than the diameter (c in FIG. 3) of the through hole 50 in the first directions DR2. Although the diameter (b in FIG. 3) of the deformed elastic body 90 is smaller than the diameter of the through hole 50, when the insertion device 20 releases pulling of the deformed elastic body 90, the deformed elastic body 90 expands in the first directions DR2, and the deformed elastic body 90 and the peripheral wall part 51 are brought into close contact with each other.

As illustrated in FIG. 6, the insertion part 81 and the peripheral wall part 51 are in close contact with each other. Force acts on the peripheral wall part 51 in a direction in which the insertion part 81 expands, so that the insertion part 81 bites into the peripheral wall pad 51 (the insertion part 81 bites into sheets of the sheet bundle S). As a result, scattering of the sheet bundle S is suppressed. Therefore, the sheet bundle S can be firmly bound.

As illustrated in FIG. 7, the unevenness 83 is formed on the surface of the insertion part 81. As a result, the peripheral wall part 51 easily bites into the insertion part 81. Therefore, the sheet bundle S can be more firmly hound, and the inserted elastic body 80 can be prevented from coming off the sheet bundle S.

As illustrated in FIG. 5, a configuration is adopted in which the deformed elastic body 90 is elastically deformed and inserted through the through hole 50, and then in a state in which pulling of the deformed elastic body 90 is released, the cutter 70 cuts the inserted elastic body 80, whereby cutting can be performed in a state in which the inserted elastic body 80 and the peripheral wall part 51 are in close contact with each other reliably. As a result, the sheet bundle S can be firmly bound. Further, since the inserted elastic body 80 can be cut with an appropriate length, the material cost can be suppressed.

Note that, a configuration may be adopted in which the deformed elastic body 90 is elastically deformed and inserted through the through hole 50, and then in a state in which the deformed elastic body 90 does not release pulling, the cutter 70 cuts the deformed elastic body 90. Even when a configuration is adopted in which the deformed elastic body 90 is inserted through the through hole 50, and then the deformed elastic body 90 is cut on the upstream side of the one direction DR3 of the thickness directions with respect to the sheet bundle 5, an effect is obtained that the sheet bundle S can be firmly bound.

The undeformed elastic body 10 has a linear shape. Since the undeformed elastic body 10 with the linear shape has a long shape in one direction, the sheet bundle S can be bound regardless of the thickness of the sheet bundle S.

The undeformed elastic body 10 is wound by the winder 40 and arranged in a wound shape. As a result, the undeformed elastic body 10 can be compactly accommodated.

The holder 30 holds the undeformed elastic body 10 from the upstream side of the one direction DR3 of the thickness directions with respect to the sheet bundle S. As a result, the force acts pulling the undeformed elastic body 10 toward the upstream side of the one direction DR3 of the thickness directions, so that the undeformed elastic body 10 is elastically deformed easily.

<Binding Method>

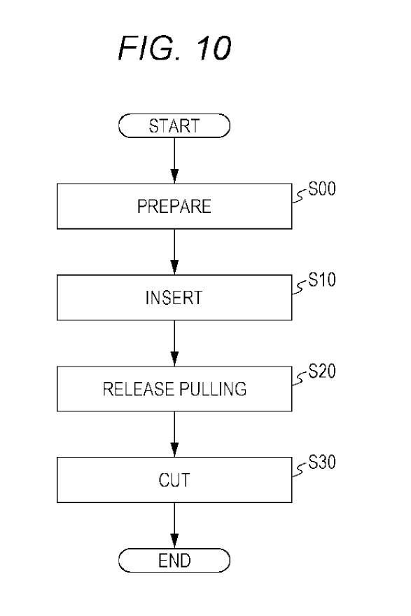

FIG. 10 is a flowchart illustrating steps of a binding method of the sheet bundle S in the first embodiment. With reference to FIGS. 2 to 5, and 10, the steps of the binding method of the sheet bundle S will be described.

In the binding method of the sheet bundle S in the embodiment, first, the undeformed elastic body 10 is prepared (S00). Next, in step (S10), the insertion device 20 is moved to a position corresponding to the through hole 50, the insertion device 20 is inserted through the through hole 50 as illustrated in FIGS. 2 and 3, the undeformed elastic body 10 is gripped by the grip 21, and the undeformed elastic body 10 is pulled in the one direction DR3 of the thickness directions. At this time, the undeformed elastic body 10 is held by the holder 30 from the upstream side of the one direction DR3 of the thickness directions with respect to the sheet bundle S.

By holding the undeformed elastic body 10, the force acts pulling the undeformed elastic body 10 toward the upstream side of the one direction DR3 of the thickness directions, so that the undeformed elastic body 10 is elastically deformed easily.

When the undeformed elastic body 10 is pulled and elastically deformed in the thickness directions DR1, the diameter of the undeformed elastic body 10 becomes smaller, and the deformed elastic body 90 whose diameter has become smaller than the diameter of the undeformed elastic body 10, can be inserted through the through hole 50.

In step (S10), the deformed elastic body 90 is inserted through the through hole 50 while being pulled toward the one direction DR3 of the thickness directions.

Next, in step (S20), the deformed elastic body 90 is inserted through the through hole 50, and then pulling of the deformed elastic body 90 is released as illustrated in FIG. 4. As a result, the deformed elastic body 90 tends to return to its original shape (shape of the undeformed elastic body 10), and the outer diameter of the deformed elastic body 90 increases (the deformed elastic body 90 expands in the radial direction).

Next, in step (S30), as illustrated in FIG. 5, the inserted elastic body 80 is cut on the upstream side of the one direction DR3 of the thickness directions with respect to the sheet bundle S. After the inserted elastic body 80 is cut, the sheet bundle S is bound by the inserted elastic body 80 left in the sheet bundle S.

The step is provided of releasing pulling of the deformed elastic body 90, whereby cutting can be performed in a state in which the inserted elastic body 80 and the peripheral wall pad 51 are in close contact with each other reliably. Note that, even in a ease where there is no step of releasing pulling of the deformed elastic body 90, the effect is obtained that the sheet bundle S can be bound, as in a case where there is the step of releasing.

By going through steps (S00) to (S30) illustrated in FIG. 10, the sheet bundle S illustrated in FIG. 1 is bound.

### Second Embodiment

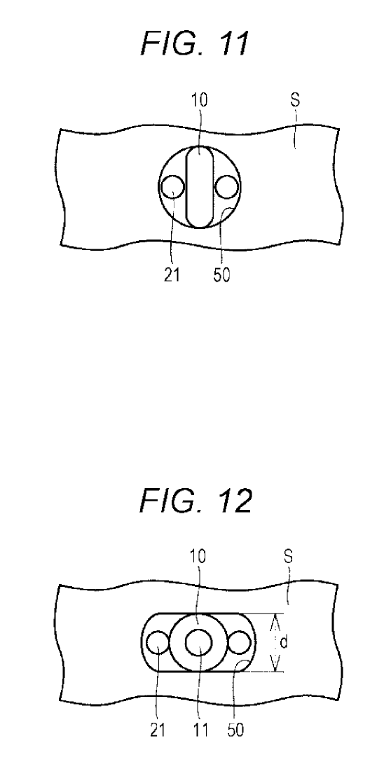

FIG. 11 is a cross-sectional view illustrating an undeformed elastic body 10 of a second embodiment inserted through a through hole 50. FIG. 11 illustrates a cross section in a plane orthogonal to thickness directions DR1. Unlike the first embodiment, in the plane orthogonal to the thickness directions DR1, the cross-sectional shape of the undeformed elastic body 10 is elliptical. The cross-sectional shape of the undeformed elastic body 10 in the plane orthogonal to the thickness directions DR1 is different from the cross-sectional shape of the through hole 50. As a result, a gap is formed between the undeformed elastic body 10 and the through hole 50, and the undeformed elastic body 10 is easily gripped by the grip 21. Therefore, the undeformed elastic body 10 is easily inserted through a sheet bundle S.

### Third Embodiment

FIG. 12 is a cross-sectional view illustrating an undeformed elastic body 10 of a third embodiment inserted through a through hole 50. Unlike the first embodiment, a hollow part 11 is formed inside the undeformed elastic body 10 of the third embodiment. The hollow part 11 extends in a direction in which the undeformed elastic body 10 extends. As a result, stretchability of the undeformed elastic body can be improved.

Further, unlike the first embodiment, the cross-sectional shape of the through hole 50 is elliptical in a plane orthogonal to thickness directions DR1. Since the cross-sectional shape of the undeformed elastic body 10 of the third embodiment is circular, the cross-sectional shape of the undeformed elastic body 10 is different from the cross-sectional shape of the through hole 50. As a result, as in the second embodiment, the undeformed elastic body 10 is easily inserted through a sheet bundle S. Note that, in a case where the through hole 50 is elliptical as in the third embodiment, the diameter of the through hole 50 indicates the short diameter part (d in FIG. 12).

### Fourth Embodiment

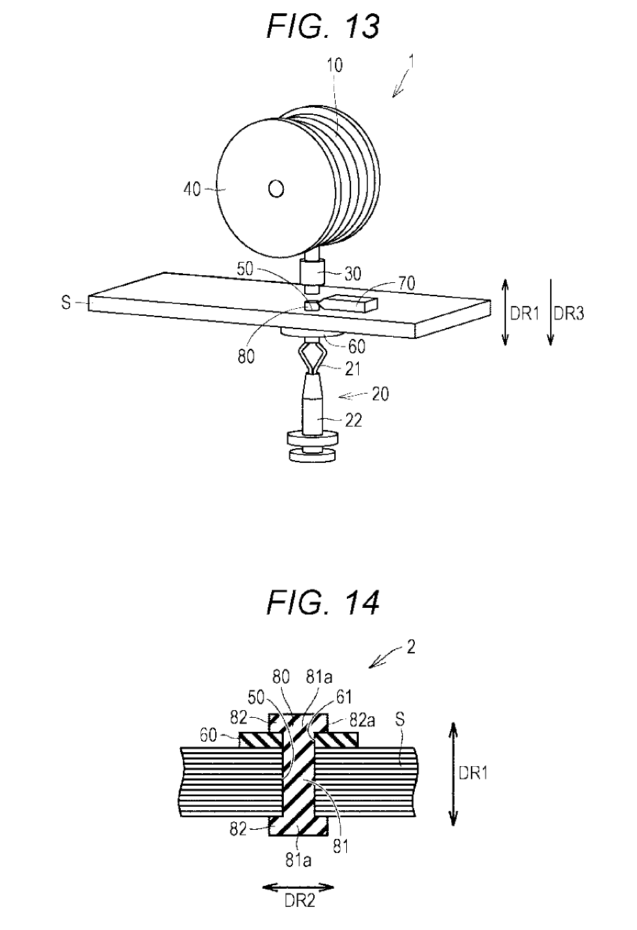

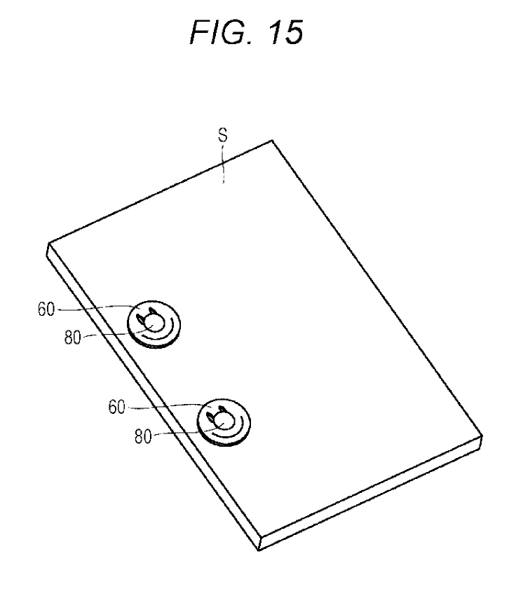

FIG. 13 is a schematic perspective view illustrating a binding apparatus 1 of a fourth embodiment. FIG. 14 is a schematic cross-sectional view of a binding structure 2 of the fourth embodiment. FIG. 15 is a schematic perspective view of a sheet bundle S after being bound. With reference to FIGS. 13 to 15, the binding apparatus 1. and the binding structure 2 of the fourth embodiment will be described.

The binding structure 2 of the fourth embodiment further includes a plate-like part 60. The plate-like part 60 is arranged between at least one of a pair of sandwiching parts 82 and the sheet bundle S. In the fourth embodiment, the plate-like part 60 is in contact with the sheet bundle S. The plate-like part 60 faces the sheet bundle S. The plate-like part 60 is arranged on the sheet bundle S. One of the sandwiching parts 82 presses the sheet bundle S via the plate-like part 60.

In the plate-like part 60, a hole part 61 is formed penetrating the plate-like part 60 in thickness directions DR1. The hole part 61 communicates with a through hole 50. An insertion part 81 is inserted through the through hole 50 and the hole part 61. At least one of the pair of sandwiching parts 82 sandwiches the sheet bundle via the plate-like part 60.

In first directions DR2, end parts 82a of the sandwiching parts 82 are provided outside the hole part 61. The end parts 82a are provided outside in the radial direction of the insertion part 81 from the hole part 61, The lengths of sandwiching parts 82 in the first directions DR2 are larger than the diameter of the hole part 61. An undeformed elastic body 10 has the length larger than the diameter of the hole part 61 in the first directions DR2.

In steps of inserting the undeformed elastic body 10 through the through hole 50 in the fourth embodiment, the undeformed elastic body 10 is inserted through the through hole 50 and the hole part 61. After a deformed elastic body 90 is inserted through the hole part 61, an insertion device 20 releases pulling, and a cutter 70 cuts an inserted elastic body 80. The undeformed elastic body 10 is inserted to sandwich the sheet bundle S via the plate-like part 60 after insertion. In this way, the sheet bundle S can be bound by arranging the plate-like part 60 between the inserted elastic body 80 and the sheet bundle S.

As a result, since an area can be increased through which the inserted elastic body 80 presses the sheet bundle S, the sheet bundle S can be more firmly bound. Further, as illustrated in FIG. 15, it is possible to improve the appearance by using the plate-like part 60 as an accessory.

### Fifth Embodiment

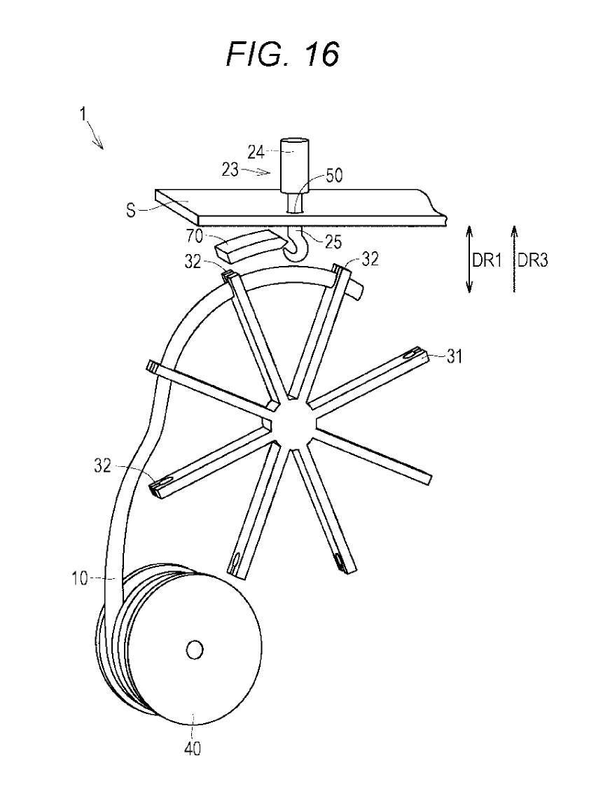

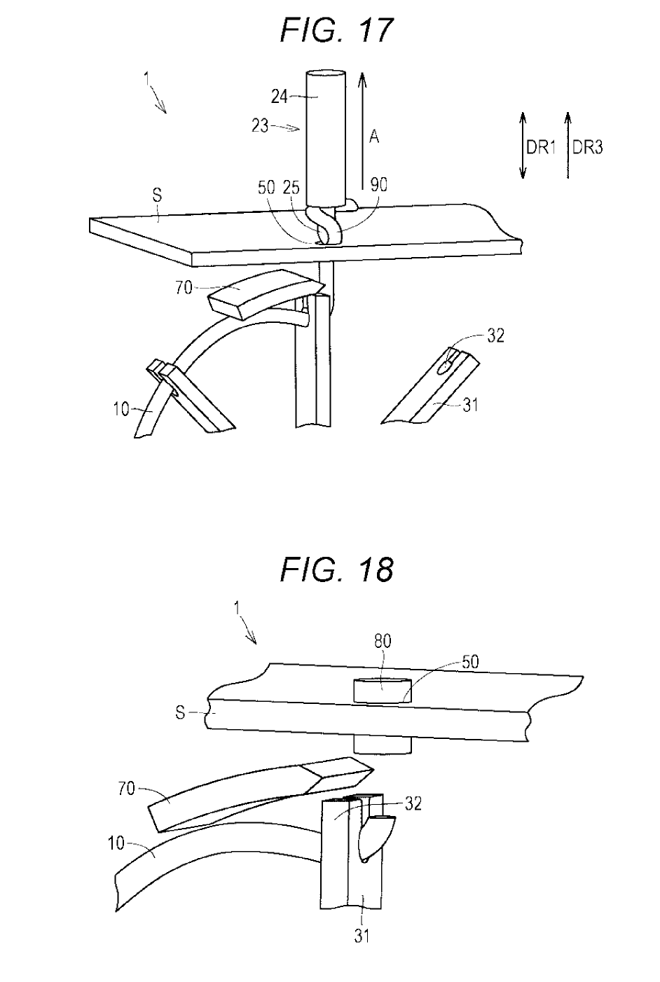

FIG. 16 is a schematic perspective view illustrating a binding apparatus 1 of a fifth embodiment. FIG. 17 is a schematic perspective view of a crochet hook 23 that pulls an undeformed elastic body 10 to one direction DR3 of the thickness directions. FIG. 18 is a schematic perspective view illustrating a state in which an inserted elastic body 80 of the fifth embodiment is cut. With reference to FIGS. 16 to 18, the binding apparatus 1 of the fifth embodiment will be described.

Unlike the first embodiment, the binding apparatus 1 of the fifth embodiment includes a rotary holder 31 and the crochet hook 23 as an insertion device 20. The crochet hook 23 includes a main body 24 and a hook 25. The hook 25 protrudes from the main body 24. The hook 25 can be taken in and out from the main body 24.

The rotary holder 31 includes a plurality of slits 32. In the slits 32, the undeformed elastic body 10 is held. Between the slits 32, the undeformed elastic body 10 is held in an arc shape.

The hook 25 extends toward a space between the slits 32, and hooks the undeformed elastic body 10 between the slits 32 to draw the undeformed elastic body 10 in the one direction DR3 of the thickness directions (arrow A in FIG. 17). After a deformed elastic body 90 is inserted through a through hole 50, as illustrated in FIG. 18, a cutter 70 cuts the inserted elastic body 80. A sheet bundle S is bound by the inserted elastic body 80 left in the sheet bundle S.

Also in the fifth embodiment, as in the first embodiment, the binding apparatus 1 and it binding structure 2 can be implemented that make it possible to easily remove the inserted elastic body 80 with simple configurations.

### Sixth Embodiment

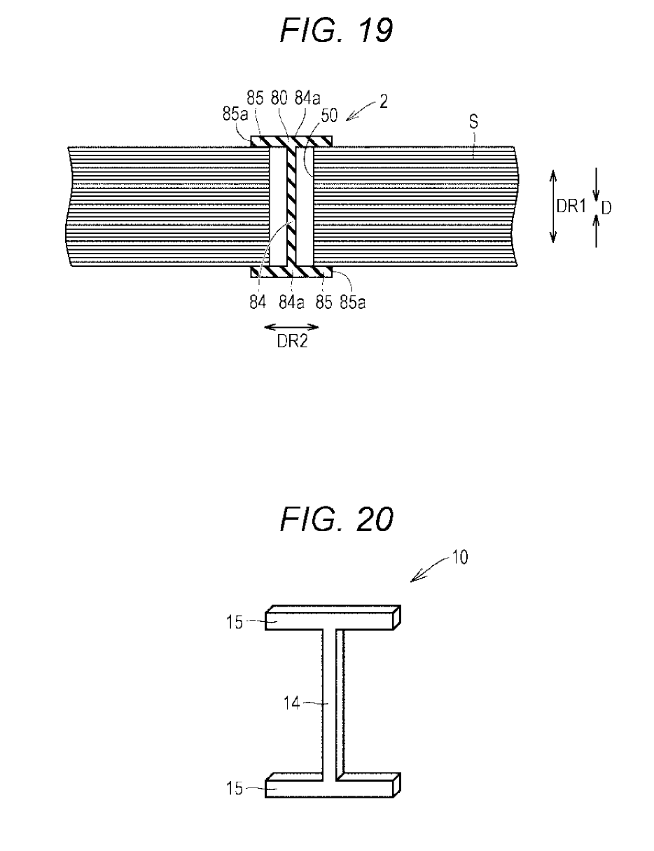

FIG. 19 is a schematic cross-sectional view illustrating a binding structure 2 of a sixth embodiment. FIG. 20 is a schematic perspective view of an undeformed elastic body 10 of the sixth embodiment. Unlike the first embodiment, the undeformed elastic body 10 made of an elastic material includes an undeformed shaft part 14 having a bar shape, and a pair or undeformed bar parts 15 each having a bar shape. The undeformed shaft part 14 and the undeformed bar parts 15 are orthogonal to each other. The length of the undeformed shaft part 14 in thickness directions DR1 is smaller than the length of a through hole 50 in the thickness directions DR1.

The undeformed elastic body 10 is inserted through the through hole 50, whereby the undeformed elastic body 10 becomes an inserted elastic body 80, and a sheet bundle S is bound. The inserted elastic body 80 of the sixth embodiment includes an inserted shall part 84 and inserted bar parts 85. The inserted shaft part 84 corresponds to the insertion part 81 (see FIG. 6) of the first embodiment, and the inserted bar parts 85 correspond to the sandwiching parts 82 of the first embodiment.

The inserted shaft part 84 is inserted through the through hole 50. The inserted shaft part 84 extends along the thickness directions DR1. The undeformed shall part 14 is inserted into the through hole 50 and elastically deformed, whereby the undeformed shaft part 14 becomes the inserted shaft part 84. Since the undeformed shaft part 14 is elastically deformed, the length of the inserted shaft part 84 in the thickness directions DR1 is larger than the length of the undeformed shaft part 14 in the thickness directions DR1.

The inserted bar parts 85 protrude in first directions DR2 from both ends 84a in the thickness directions DR1 of the inserted shaft part 84, respectively. The inserted bar parts 85 are orthogonal to the inserted shall part 84. The pair of inserted bar parts 85 presses the front and back surfaces of the sheet bundle S in the thickness directions DR1. In the first directions DR2, end parts 85a of the inserted bar parts 55 are provided outside the through hole 50. In the first directions DR2, the lengths of the inserted bar parts 85 are larger than the diameter of the through hole 50.

The inserted shaft part 84 is inserted through the through hole 50 while remaining in an extended state. The inserted shall part 54 is in the extended state to cause the pair of inserted bar parts 85 to generate elastic biasing force in a direction (D in FIG. 19) in which the sheet bundle S is sandwiched. Due to action of the inserted shaft part 84 in the extended state contracting, the pair of inserted bar parts 85 generates the elastic biasing force on the sheet bundle S in the direction in which the sheet bundle S is sandwiched.

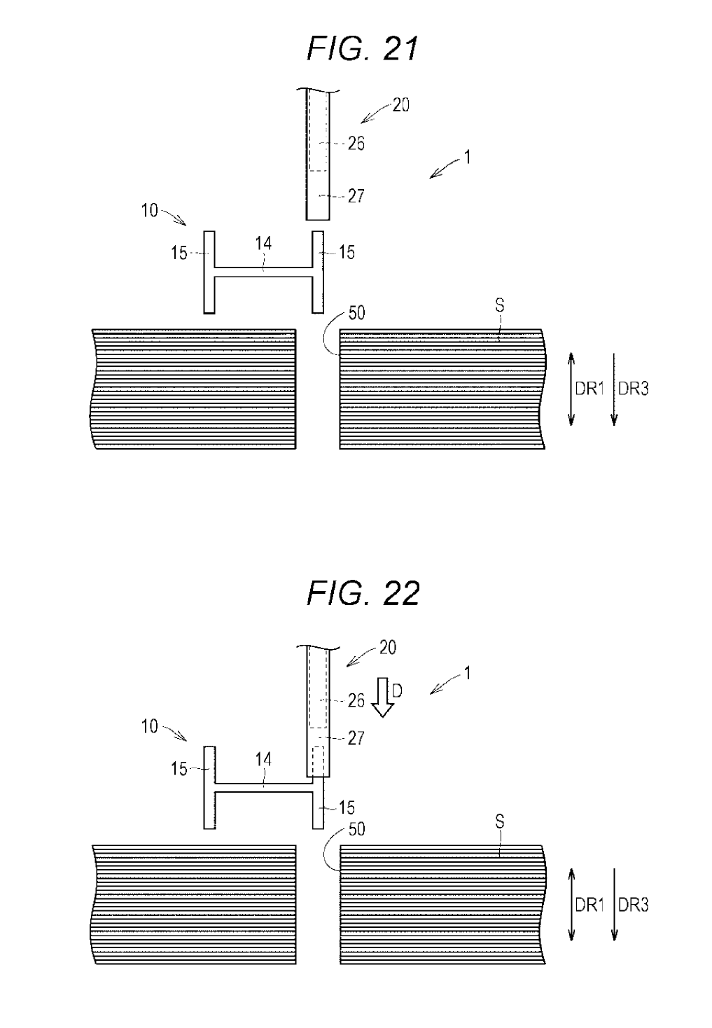

FIG. 21 is a schematic cross-sectional view illustrating a binding apparatus 1 of the sixth embodiment. FIG. 22 is a schematic cross sectional view illustrating the binding apparatus 1 of the sixth embodiment immediately before the undeformed elastic body 10 is inserted through the through hole 50.

An insertion device 20 of the sixth embodiment includes an extruder 26 and a main body 27. The extruder 26 is provided inside the main body 27. The extruder 26 is movable in the thickness directions DR1, and can protrude toward the outside of the main body 27. The main body 27 is movable in the thickness directions DR1. The main body 27 moves in one direction DR3 (downward direction in FIG. 21) of the thickness directions, and one end of one of the undeformed bar parts 15 is inserted into the main body 27. In that state, the main body 27 moves to the Sane direction DR3 of the thickness directions (direction D in FIG. 22).

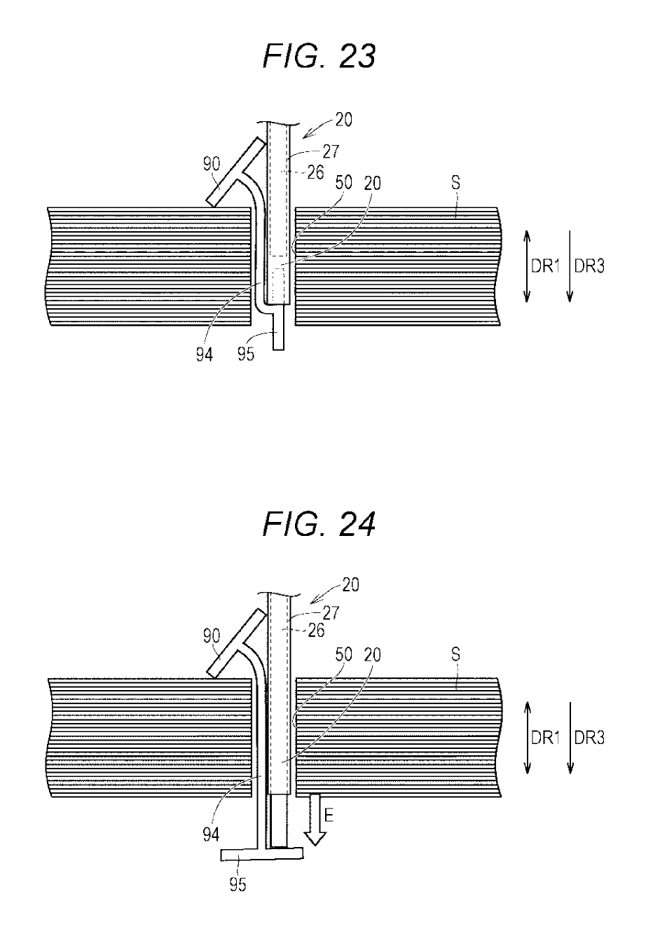

FIG. 23 is a schematic cross-sectional view illustrating a deformed elastic body 90 of the sixth embodiment. The undeformed elastic body 10 is elastically deformed by being pulled to the one direction DR3 of the thickness directions, and becomes the deformed elastic body 90. The undeformed shaft part 14 and one of the undeformed bar parts 15 become a deformed shaft part 94 and a deformed bar part 95, respectively. The deformed elastic body 90 is inserted through the through bolo 50 as the main body 27 moves.

FIG. 24 is a schematic cross-sectional view illustrating the deformed elastic body 90 of the sixth embodiment immediately before the deformed elastic body 90 is attached to the sheet bundle S. The extruder 26 protrudes toward the outside from the inside of the main body 27 (direction E in FIG. 24), and extrudes the deformed bar part 95 to the outside of the main body 27.

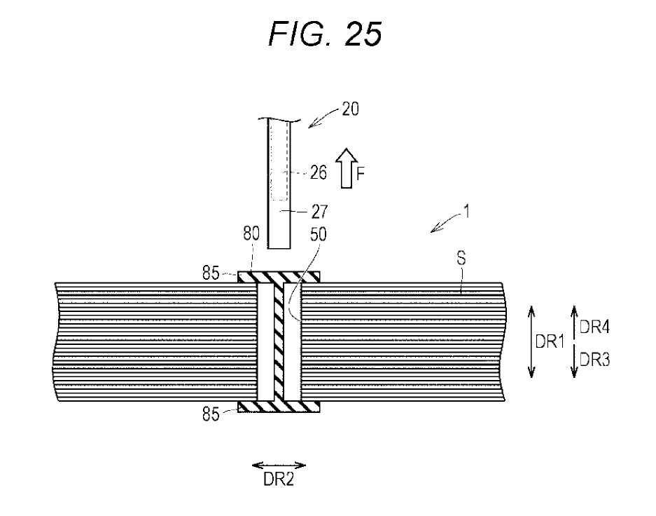

FIG. 25 is a schematic cross-sectional view illustrating the inserted elastic body of the sixth embodiment. After the deformed bar part 95 is extruded toward the outside from the inside of the main body 27, the insertion device 20 moves toward another direction DR4 of the thickness directions to retreat (direction F in FIG. 25). The insertion device 20 moves to the outside of the through hole 50. As a result, the deformed elastic body 90 is attached to the sheet bundle S.

In a state after the deformed elastic body 90 is inserted through the through hole 50, the deformed elastic body 90 becomes the inserted elastic body 80, and the inserted elastic body 80 presses the sheet bundle S the thickness directions DR1, whereby the sheet bundle S is bound.

Also in the sixth embodiment, the binding apparatus 1 and the binding structure 2 can be implemented that make it possible to easily remove the inserted elastic body 80 with simple configurations. Further, unlike the first embodiment, since a cutter 70 is not required, the configuration can be further simplified.

Note that, in the sixth embodiment, a configuration may be adopted in which the plate-like part 60 (see FIG. 14) of the second embodiment is arranged between the inserted bar parts 85 and the sheet bundle S. Also in this case, as in the fourth embodiment, the effect is obtained that the sheet bundle S can be more firmly bound.

### Others

In the embodiments, a configuration may be adopted in which the sheet bundle S is bound only by inserting the undeformed elastic body 10 of an appropriate length through the through hole 50. In this case, since the cutter 70 is not required, the configuration of the binding apparatus 1 and the binding method can be simplified.

In the embodiments, the configuration is adopted in which the insertion device 20 is movable to cause the position of the insertion device 20 to correspond to the position of the through hole 50; however, a configuration may be adopted in which the sheet bundle S is moved by a movement mechanism, to cause the position of insertion device 20 to correspond to the position of the through hole 50.

Although embodiments of the present invention have been described and illustrated in detail, the disclosed embodiments are made for purposes of illustration and example only and not limitation. The scope of the present invention should be interpreted by terms of the appended claims, and it is intended that meanings equivalent to the claims and all modifications within the scope are included.

What is claimed is:

1. A binding structure that binds a bundle of recording media, the binding structure comprising
an inserted elastic body that is stretchable and inserted through a through hole formed in the bundle of the recording media, wherein
the inserted elastic body includes an insertion part that extends along a thickness direction of the bundle of the recording media and is inserted through the through hole, and a pair of sandwiching parts that is provided at both ends of the insertion part in the thickness direction mid sandwiches the bundle of the recording media, and
the insertion part is in an extended state to cause the pair of sandwiching parts to generate elastic biasing force in a direction in which the bundle of the recording media is sandwiched.

2. The binding structure according to claim 1, further comprising
a plate-like part arranged between at least one of the pair of sandwiching parts and the bundle of the recording media, wherein
the plate-like part is formed with a hole part that penetrates in the thickness direction and communicates with the through hole,
the insertion part is inserted through the through hole and the hole part, and
at least one of the pair of sandwiching parts sandwiches the bundle of the recording media via the plate-like part.

3. The binding structure according to claim 1, wherein the insertion part is in close contact with a peripheral wall part of the bundle of the recording media that defines the through hole.

4. The binding structure according to claim 3, wherein unevenness is provided on a surface of the insertion part.

5. A binding apparatus comprising
an insertion devisee that inserts an undeformed elastic body that is stretchable, through a through hole formed in a bundle of recording media, wherein
the undeformed elastic body is inserted through the through hole to generate elastic biasing force in a direction in which the bundle of the recording media is sandwiched after insertion.

6. The binding apparatus according to claim 5, wherein
an inserted elastic body that is in a state after the undeformed elastic body is inserted through the through hole, includes an insertion part that extends along a thickness direction of the bundle of the recording media and is inserted through the through hole, and a pair of sandwiching parts that is provided at both ends of the insertion part in the thickness direction and sandwiches the bundle of the recording media,
the insertion part is in an extended state to cause the pair of sandwiching parts to generate elastic biasing force in a direction in which the bundle of the recording media is sandwiched,
a hole part that penetrates in the thickness direction and communicates with the through hole is formed in a plate-like part arranged between at least one of the pair of sandwiching parts and the bundle of the recording media,
the insertion part is inserted through the through hole and the hole part, and
at least one of the pair of sandwiching parts sandwiches the bundle of the recording media via the plate-like part.

7. The binding apparatus according to claim 5, wherein
the undeformed elastic body has a length larger than a diameter of the through hole in a first direction orthogonal to thickness directions of the bundle of the recording media, and
the binding apparatus further comprises a cutter, wherein the insertion device pulls the undeformed elastic body in one direction of the thickness directions to form a deformed elastic body, and inserts the deformed elastic body through the through hole, and then the cutter cuts the deformed elastic body on an upstream side in the one direction of the thickness directions with respect to the bundle of the recording media.

8. The binding apparatus according to claim 5, wherein
the undeformed elastic body has a length larger than a diameter of the through hole in a first direction orthogonal to thickness directions of the bundle of the recording media, and
the binding apparatus further comprises a cutter, wherein the insertion device pulls the undeformed elastic body in one direction of the thickness directions to form a deformed elastic body, and inserts the deformed elastic body through the through hole, and then in a state in which the insertion device releases pulling of the deformed elastic body, the cutter cuts the inserted elastic body that is in a state in which pulling of the deformed elastic body is released, on an upstream side in the one direction of the thickness directions with respect to the bundle of the recording media.

9. The binding apparatus according to claim 5, wherein a cross-sectional shape of the undeformed elastic body in a plane orthogonal to a thickness direction of the bundle of the recording media is different from a cross-sectional shape of the through hole.

10. The binding apparatus according to claim 5, wherein a hollow part is formed inside the undeformed elastic body.

11. The binding apparatus according to claim 5, wherein unevenness is provided on a face of the undeformed elastic body.

12. The binding apparatus according to claim 5, wherein the undeformed elastic body has a linear shape.

13. The binding apparatus according to claim 12, wherein the undeformed elastic body is arranged in a wound shape.

14. The binding apparatus according to claim 5, further comprising a holder that is arranged on an upstream side in one direction of thickness directions of the bundle of the recording media with respect to the bundle of the recording media and holds the undeformed elastic body.

15. A binding method comprising:
preparing an undeformed elastic body that is stretchable; and
inserting the undeformed elastic body through a through hole formed in a bundle of recording media, in this order, wherein
the undeformed elastic body is inserted through the through hole to generate elastic biasing force in a direction in which the bundle of the recording media is sandwiched after insertion.

16. The binding method according to claim 15, wherein
the undeformed elastic body has a length larger than a diameter of the through hole in a first direction orthogonal to thickness directions of the bundle of the recording media,
in inserting the undeformed elastic body through the through hole, the undeformed elastic body is pulled toward one direction of the thickness directions to be formed as a deformed elastic body, and the deformed elastic body is inserted through the through hole, and
the binding method further comprises cutting the deformed elastic body on an upstream side in the one direction of the thickness directions with respect to the bundle of the recording media after inserting the deformed elastic body through the through hole.

17. The binding method according to claim 15, wherein
the undeformed elastic body has a length larger than a diameter of the through hole in a first direction orthogonal to thickness directions of the bundle of the recording media,
in inserting the undeformed elastic body through the through hole, the undeformed elastic body is pulled toward one direction of the thickness directions to be formed as a deformed elastic body, and the deformed elastic body is inserted through the through hole, and
the binding method further comprises forming an inserted elastic body by releasing pulling of the deformed elastic body after inserting the deformed elastic body through the through hole.

18. The binding method according to claim 17, further comprising cutting the inserted elastic body on at upstream side in the one direction of the thickness directions with respect to the bundle of the recording media after releasing pulling of the deformed elastic body.

19. The binding method according to claim 15, wherein a cross-sectional shape of the undeformed elastic body in a plane orthogonal to a thickness direction of the bundle of the recording media is different from a cross-sectional shape of the through hole.

20. The binding method according to claim 15, wherein a hollow part is formed inside the undeformed elastic body.

21. The binding method according to claim 15, wherein unevenness is provided on a surface of the undeformed elastic body.

22. The binding method according to claim 15, wherein
in inserting the undeformed elastic body through the through hole, the undeformed elastic body is inserted through the through hole and a hole part that is formed in a plate-like part arranged on the bundle of the recording media and penetrates in a thickness direction of the bundle of the recording media, and
the undeformed elastic body is inserted to sandwich the bundle of the recording media via the plate-like part after insertion.

23. The binding method according to claim 15, wherein the undeformed elastic body has a linear shape.

24. The binding method according to claim 23, wherein the undeformed elastic body is arranged in a wound shape.

25. The binding method according to claim 15, wherein in inserting the undeformed elastic body through the through hole, the undeformed elastic body is held from an upstream side in one direction of thickness directions of the bundle of the recording media with respect to the bundle of the recording media.
